(19) United States
(12) Patent Application Publication
(10) Pub. No.: US 2026/0271163 A1
(43) Pub. Date: Sep. 10, 2026

(54) LIGHTING CONTROL CIRCUIT

(71) Applicant: JIANGXI SUPERSUN TECHNOLOGY LIGHTING CO., LTD, Shangrao (CN)

(72) Inventors: Lizhen Wang, Shangrao (CN); Jiaqi Ye, Shangrao (CN); Jintao Jin, Shangrao (CN); Ziwei Ye, Shangrao (CN)

(21) Appl. No.: 19/190,840

(22) Filed: Apr. 28, 2025

(30) Foreign Application Priority Data
Mar. 4, 2025 (CN) 202510247400.0

(51) Int. Cl. H05B 47/17; H02J 9/06; H05B 45/10; H05B 45/20; H05B 47/11; H05B 47/115

(52) U.S. Cl. CPC H05B 47/172; H02J 9/061; H05B 45/10; H05B 45/20; H05B 47/11; H05B 47/115

(57) ABSTRACT

The preset invention belongs to the technical field of lighting, and discloses a lighting control circuit. The circuit includes a main lighting management unit and an auxiliary lighting management unit; the auxiliary lighting management unit is formed by an auxiliary lighting lamp, a battery control circuit, an auxiliary lighting control circuit and a sensing module; the auxiliary lighting control circuit is capable of adjusting brightness of the auxiliary lighting lamp to meet demands of a user on different light intensities; the sensing module is capable of automatically controlling on/off of the auxiliary lighting lamp according to external ambient light and a moving object so as to realize a self-induced on/off function, thus achieving purposes of energy saving and more humanized design; the battery control circuit is capable of normally supplying power to the auxiliary lighting lamp after power failure, thus ensuring continuous lighting.

### CROSS-REFERENCE TO RELATED APPLICATIONS

This application claims priority to Chinese Patent Application No. CN202510247400.0, filed with the China National Intellectual Property Administration on Mar. 4, 2025 and entitled “LIGHTING CONTROL CIRCUIT”, which is incorporated herein by reference in its entirety.

### FIELD OF THE INVENTION

The present invention relates to the technical field of lighting, and particularly relates to a lighting control circuit.

### BACKGROUND OF THE INVENTION

In the field of indoor lighting, a product that has both light strip and night light function is widely used. At present, the night light control on this kind of product relies on a wall switch to switch many times to realize the lighting, and if there is no need to use, a user also needs to manually turn off the switch again, so existing night lights generally only have a continuous lighting mode, are lack of light sensitivity and the ability of sensing objects, human body, cannot automatically control on and off according to ambient light and surrounding objects, are difficult to meet the demand for energy saving, and moreover, the existing night lights completely depend on the mains supply, once the mains supply is interrupted, they cannot work, so the use scene is limited. In addition, the brightness of the existing night lights is fixed and cannot be adjusted, so they cannot adapt to the personalized needs of different users for light intensity in different environments, and as a result, the existing indoor light products with the night light function have obvious deficiencies in control convenience, functional diversity, energy saving, power supply flexibility and brightness adjustment, etc. It is urgent to innovate and improve to improve the user experience.

### SUMMARY OF THE INVENTION

A main objective of the present application is to provide a lighting control circuit to solve the technical problems that existing products with both light strip and night light function are unadjustable in brightness, do not have a self-induced turn off function and cannot be used in power failure, resulting in obvious deficiencies in control convenience, functional diversity, energy saving, power supply flexibility and brightness adjustment, etc.

In order to achieve the above object, the present invention provides a lighting control circuit, including a main lighting management unit, and an auxiliary lighting management unit connected to the main lighting management unit, in which
the auxiliary lighting management unit includes an auxiliary lighting lamp, a battery control circuit, an auxiliary lighting control circuit, and a sensing module, in which the auxiliary lighting lamp is connected to the auxiliary lighting control circuit, and the auxiliary lighting control circuit is configured to adjust the brightness of the auxiliary lighting lamp;
the battery control circuit is connected to the auxiliary lighting lamp by means of the auxiliary lighting control circuit, and is configured to normally supply power to the auxiliary lighting lamp after power failure; and
a first end of the sensing module is connected to the main lighting management unit, a second end of the sensing module is connected to the auxiliary lighting control circuit by means of the battery control circuit, and the sensing module is configured to control an on-off state of the auxiliary lighting lamp according to external ambient light and whether a moving object exists.

Further, the battery control circuit includes a battery pack, a charging management circuit, a signal detection circuit and a battery charging circuit which are connected to the battery pack respectively; the signal detection circuit is configured to detect a sensing signal of the sensing module and control the state of connection and disconnection between of the auxiliary lighting control circuit and the battery pack; the battery charging circuit is configured to charge the battery pack; and the charging management circuit is configured to control the charging state of the battery pack.

Further, the battery charging circuit includes a battery charging chip and a filtering battery protection circuit;
a first end of the battery charging chip is connected to the charging management circuit by means of a first inductor, and a second end of the battery charging chip is connected to the signal detection circuit by means of a first polar capacitor and is grounded; and
a first end of the filtering battery protection circuit is connected to the first end of the battery charging chip, and the second end of the filtering battery protection circuit is connected to the second end of the battery charging chip.

Further, the signal detection circuit includes a detection chip, a voltage stabilization filter circuit and a decoupling filter circuit;
a first end of the detection chip is connected to the charging management circuit, and a second end of the detection chip is connected to the second end of the battery charging chip;
a first end of the voltage stabilization filter circuit is connected to a positive electrode end of a bus, and a second end of the voltage stabilization filter circuit is connected to a connecting line between the second end of the detection chip and the second end of the battery charging chip; and
a first end of the decoupling filter circuit is connected to a connecting line between the first end of the detection chip and the charging management circuit, and the second end of the decoupling filter circuit is grounded.

Further, the charging management circuit includes a charging management chip, a rectification protection circuit and an indicating circuit;
the rectification protection circuit is connected to the first end of the battery charging chip, the first end of the detection chip and the charging management chip respectively;
a first end of the charging management chip is connected to a positive electrode end of the battery pack, and a second end of the charging management chip is connected to a negative electrode end of the battery pack and is grounded; and
a first end of the indicating circuit is connected to the first end of the charging management chip, and a second end of the indicating circuit is connected to the second end of the charging management chip.

Further, the auxiliary lighting control circuit includes an auxiliary lighting control chip, a first transistor and a power switching protection circuit;
a source electrode of the first transistor is connected to the battery control circuit, and a drain electrode of the first transistor is connected to the first end of the auxiliary lighting control chip by means of a first resistor; and
a second end of the auxiliary lighting control chip is connected to the power switching protection circuit by means of a second resistor, a first end of the auxiliary lighting lamp is connected to the second end of the auxiliary lighting control chip, and a second end of the auxiliary lighting lamp is connected to the power switching protection circuit.

Further, the power switching protection circuit includes a second transistor, a third resistor and a diode set;
a drain electrode of the second transistor is connected to the second end of the auxiliary lighting lamp, a grid electrode of the second transistor is connected to a first end of the third resistor, and a second end of the third resistor is grounded; and
a first end of the diode set is connected to a connecting line between a grid electrode of the second transistor and a first end of the third resistor, and a second end of the diode set is connected to a connecting line between a second end of the second resistor and the second end of the auxiliary lighting lamp.

Further, the main lighting management unit includes a rectification filter circuit, a main lighting control circuit and a main lighting lamp; the rectification filter circuit is connected to the main lighting lamp by means of the main lighting control circuit, and the rectification filter circuit comprises a rectifier diode, a resistor set and a surge circuit;
a first end of the rectifier diode is connected to the mains supply; and a second end of the rectifier diode is connected to the resistor set and the surge circuit, and the resistor set is connected to the surge circuit.

Further, the main lighting control circuit includes a main lighting control chip, a linear voltage reduction dimming circuit and a filtering phase shift circuit;
a first end of the main lighting control chip is connected to a first end of the filtering phase shift circuit, and a second end of the filtering phase shift circuit is connected to a first supporting pin of a second end of the rectifier diode; and
a second end of the main lighting control chip is connected to a first end of the linear voltage reduction dimming circuit, and a second end of the linear voltage reduction dimming circuit is connected to a fourth supporting pin of the second end of the rectifier diode and the main lighting lamp respectively.

Further, the main lighting management unit further includes a color temperature control circuit; and
the color temperature control circuit comprises a multi-position switch and a current distribution circuit, and the multi-position switch is connected to the main lighting lamp by means of the current distribution circuit.

### Beneficial Effects

a lighting control circuit according to the present invention includes a main lighting management unit, and an auxiliary lighting management unit connected to the main lighting management unit; the auxiliary lighting management unit includes an auxiliary lighting lamp, a battery control circuit, an auxiliary lighting control circuit and a sensing module, in which, the auxiliary lighting lamp is connected to the auxiliary lighting control circuit, and the auxiliary lighting control circuit is configured to adjust the brightness of the auxiliary lighting lamp; the battery control circuit is connected to the auxiliary lighting lamp by means of the auxiliary lighting control circuit, and is configured to normally supply power to the auxiliary lighting lamp after power failure; and a first end of the sensing module is connected to the main lighting management unit, a second end of the sensing module is connected to the auxiliary lighting control circuit by means of the battery control circuit, and the sensing module is configured to control the on/off state of the auxiliary lighting lamp according to external ambient light and whether a moving object exists. In this way, the battery control circuit, the auxiliary lighting control circuit and the sensing module are combined in the lighting control circuit, the brightness of the auxiliary lighting lamp can be adjusted by means of the auxiliary lighting control circuit of this circuit, the sensing module performs the self-induced turn off function, and the battery control circuit supplies power to the small night light during power failure, so that the small night light has various practical functions to meet the lighting requirements under different scenes, furthermore, the brightness adjusting function, the self-induced turn off function and the function of working in power failure are achieved, thus improving the user experience is improved; and moreover, various functions are integrated, so the application scene is widened.

### BRIEF DESCRIPTION OF THE DRAWINGS

FIG. 1 is a schematic diagram of a battery control circuit according to an embodiment of the present invention;

FIG. 2 is a schematic diagram of a battery charging circuit according to an embodiment of the present invention;

FIG. 3 is a schematic diagram of a signal detection circuit according to an embodiment of the present invention;

FIG. 4 is a schematic diagram of a charging management circuit according to an embodiment of the present invention;

FIG. 5 is a schematic diagram of an auxiliary lighting control circuit according to an embodiment of the present invention;

FIG. 6 is a schematic diagram of a main lighting management unit according to an embodiment of the present invention;

FIG. 7 is a schematic diagram of a rectification filter circuit according to an embodiment of the present invention;

FIG. 8 is a schematic diagram of a main lighting control circuit according to an embodiment of the present invention; and

FIG. 9 is a schematic diagram of a color temperature control circuit and a main lighting lamp according to embodiment of the present invention.

### REFERENCE NUMERALS IN THE FIGURES

1, main lighting management unit; 2, auxiliary lighting management unit;
10, rectification filter circuit; 11, main lighting control circuit; 12, color temperature control circuit; 13, main lighting lamp;
BD1, rectifier diode; 101, resistor set; 102, surge circuit;
SW, multi-position switch; 120, current distribution circuit;
LED5, auxiliary lighting lamp; 20, battery control circuit; 21, auxiliary lighting control circuit; U5, sensing module;
BAT, battery pack; 201, charging management circuit; 202, signal detection circuit; 203, battery charging circuit;
2030, filtering battery protection circuit; U4, battery charging chip; L1, first inductor; EC2, first polar capacitor;
U6, detection chip; 2020, voltage stabilization filter circuit; 2021, decoupling filter circuit;
U7, charging management chip; 2010, rectification protection circuit; 2011, indicating circuit;
210, power switching protection circuit; U8, auxiliary lighting control chip; Q1, first transistor; RS, first resistor; RVC, second resistor;
Q10, second transistor; and R5+, third resistor.

The implementation of the objective, the functional characteristics and the advantages of the present invention will be further described with reference to the accompanying drawings in combination with the embodiments.

### DETAILED DESCRIPTION OF SOME EMBODIMENTS

It should be understood that the specific examples described herein are only used to explain the present invention, not to pose a limitation on the present invention.

In the description of the invention, it should be understood that the orientation or position terms such as “center”, “vertical”, “horizontal”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, based on the orientation or position relationship shown in the figures, only facilitate description to the invention and simplification to the description, do not indicate or imply a certainty for the appointed device or element to have a specific orientation, be constructed and operated in a specific orientation. Therefore, they cannot be construed as a limitation on the invention. Moreover, the terms “first” and “second” are used for descriptive purposes only and cannot be understood as indicating or implying relative importance, or implicitly indicating the number of technical features indicated thereby. Therefore, the feature defined by “first” and “second” may explicitly or implicitly include one or more of the features. In the description of the present invention, the meaning of “multiple” is two or more than two, unless otherwise specifically defined.

In the present invention, the terms “installation”, “connected”, “connection”, “fixing”, and the like shall be understood in a broad sense unless otherwise specified and defined. For example, they may be fixed connection, removable connection or integrated connection; may be mechanical connection or electrical connection; and may be direct connection, or indirect connection through an intermediate medium, and connection inside two elements. The specific meanings of the above terms in the present invention may be understood in a specific case by those of ordinary skills in the art.

In the present invention, unless otherwise specified and limited, the first feature “on” or “under” the second feature may include direct contact between the first feature and the second feature, and may also include the contact between the first feature and the second feature through another feature therebetween instead of the direct contact. Furthermore, the first feature “on”, “above” and “over” the second feature includes that the first feature is directly above and obliquely above the second feature, or only indicates that the first feature is higher than the second feature in a horizontal height. The first feature “under”, “below” and “underneath” the second feature includes that the first feature is directly below and obliquely below the second feature, or only indicates that the first feature is lower than the second feature in a horizontal height.

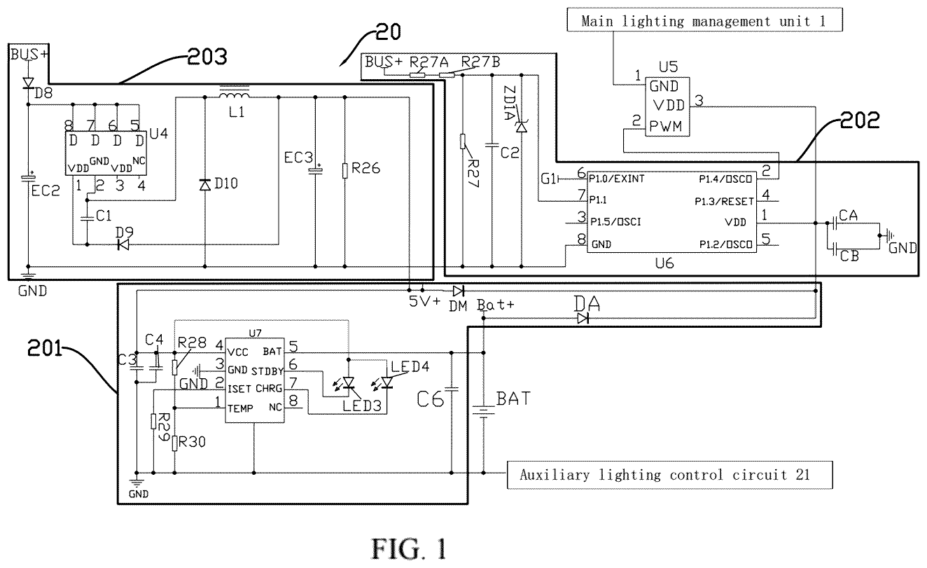

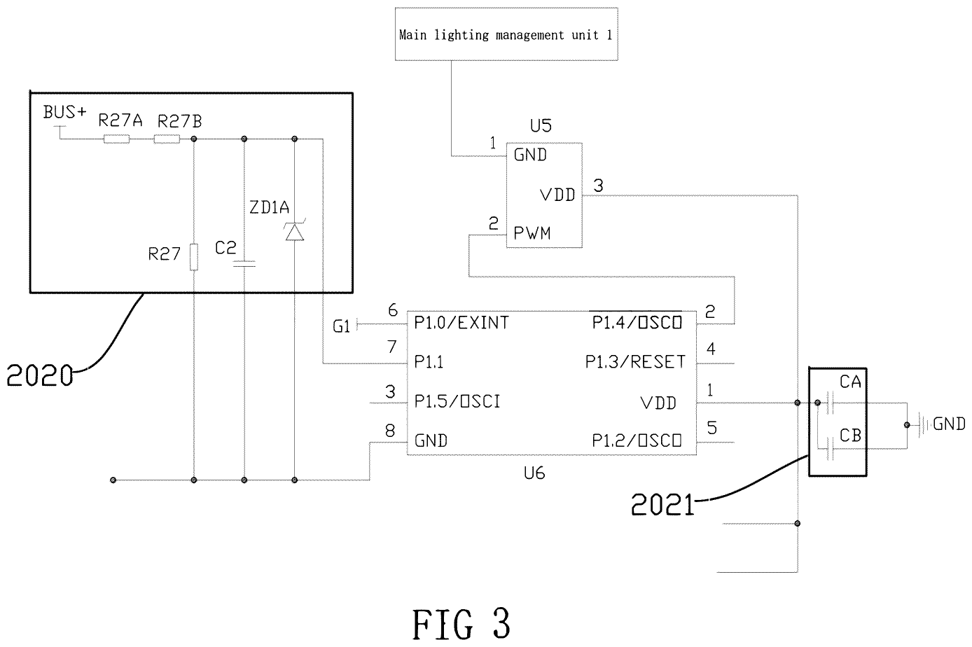

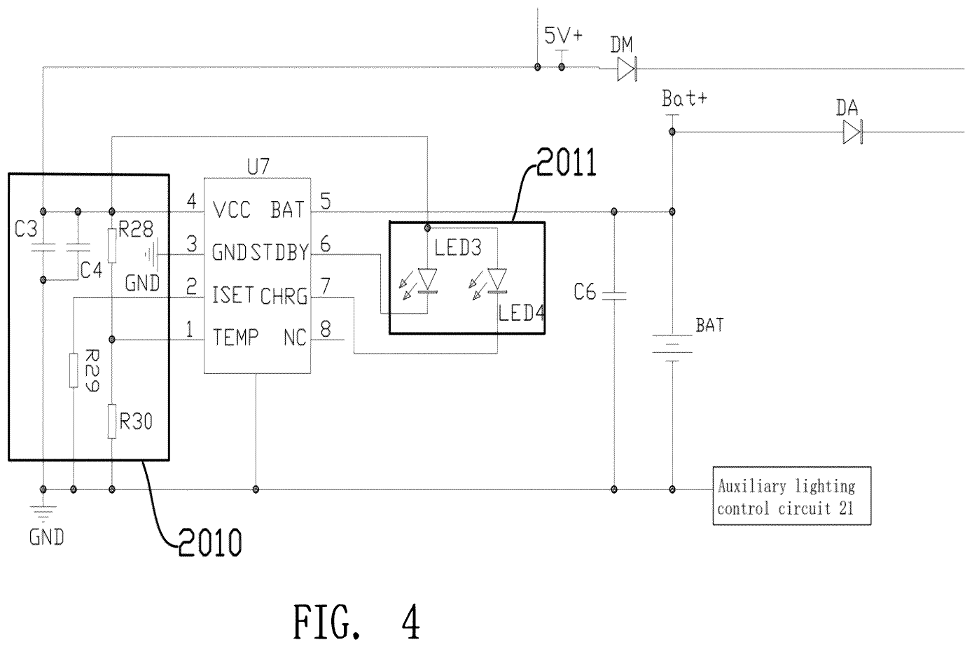

With reference to FIG. 1 to FIG. 6, an embodiment provides a lighting control circuit, which includes a main lighting management unit 1, and an auxiliary lighting management unit 2 connected to the main lighting management unit 1;
the auxiliary lighting management unit 2 includes an auxiliary lighting lamp LED5, a battery control circuit 20, an auxiliary lighting control circuit 21, and a sensing module U5, in which, the auxiliary lighting lamp LED5 is connected to the auxiliary lighting control circuit 21, and the auxiliary lighting control circuit 21 is configured to adjust the brightness of the auxiliary lighting lamp LED5;
the battery control circuit 20 is connected to the auxiliary lighting lamp LED5 by means of the auxiliary lighting control circuit 21, and is configured to normally supply power to the auxiliary lighting lamp LED5 after power failure; and
a first end of the sensing module U5 is connected to the main lighting management unit 1, a second end of the sensing module U5 is connected to the auxiliary lighting control circuit 21 by means of the battery control circuit 20, and the sensing module U5 is configured to control the on-off state of the auxiliary lighting lamp LED5 according to external ambient light and whether a moving object exists.

In the above embodiment, the lighting control circuit includes the main lighting management unit 1 and the auxiliary lighting management unit 2, in which, the main lighting management unit 1 is configured to supply power to the main lighting lamp 13 by means of mains supply and control the main lighting lamp 13, and to supply power support for the whole system; the auxiliary lighting management unit 2 focuses on the implementation of functions of a small night light (namely the auxiliary lighting lamp LED5), and is formed by a plurality of key components, specifically including the auxiliary lighting lamp LED5, the battery control circuit 20, the auxiliary lighting control circuit 21 and the sensing module U5; the auxiliary lighting lamp LED5 is configured to provide auxiliary lighting at night or under a specific condition; the battery control circuit 20 is used as an emergency power supply part, includes a battery pack BAT and a related control circuit, and is configured to ensure that power can still be supplied to the auxiliary lighting lamp LED5 when the mains supply is interrupted; the battery control circuit 20 is connected to the auxiliary lighting lamp LED5 by means of the auxiliary lighting control circuit 21 so as to stably supply power to the auxiliary lighting lamp LED5; the auxiliary lighting control circuit 21 is mainly configured to adjust the brightness of the auxiliary lighting lamp LED5, and to adjust the current magnitude to control the lighting intensity so as to meet the requirements under different scenes; the sensing module U5 is a chip with built-in light sensing and microwave sensing functions, and is configured to control the on-off of the auxiliary lighting lamp LED5 according to the external ambient light and the state of the moving object; the first end of the sensing module U5 is connected to the main lighting management unit 1, and the second end of the sensing module U5 is connected to the auxiliary lighting control circuit 21 by means of the battery control circuit 20, so that the sensing module U5 can sense the environment change in real time and transmit a signal to the auxiliary lighting control circuit 21 to control the working state of the auxiliary lighting lamp LED5, for example, in the daytime, if the light sensing module detects strong light, the auxiliary lighting lamp LED5 is kept off; and at night, if the light sensing module detects weak light, and meanwhile, a microwave sensing module detects the moving object, the auxiliary lighting lamp LED5 is turned on, and will automatically turn off after 90 s when no moving object exists. In this, the battery control circuit 20, the auxiliary lighting control circuit 21 and the sensing module U5 are combined in the lighting control circuit, the brightness of the auxiliary lighting lamp LED5 can be adjusted by means of the auxiliary lighting control circuit 21 of this circuit, the sensing module U5 performs the self-induced turn off function, and the battery control circuit 20 supplies power to the small night light during power failure, so that the small night light has various practical functions to meet the lighting requirements under different scenes, furthermore, the brightness adjusting function, the self-induced turn off function and the function of working in power failure are achieved, thus improving the user experience is improved; and moreover, various functions are integrated, so the application scene is widened.

With reference to FIG. 1, in one embodiment, the battery control circuit 20 includes a battery pack BAT, and a charging management circuit 201, a signal detection circuit 202 and a battery charging circuit 203 which are connected to the battery pack BAT respectively, in which, the signal detection circuit 202 is configured to detect a sensing signal of the sensing module U5 and control the connection and disconnection between the auxiliary lighting control circuit 21 and the battery pack BAT; the battery charging circuit 203 is configured to charge the battery pack BAT; and the charging management circuit 201 is configured to control the charging state of the battery pack BAT.

In the above embodiment, the battery control circuit 20 is a key standby power supply part in a lighting system and is formed by the battery pack BAT, the charging management circuit 201, the signal detection circuit 202 and the battery charging circuit 203, in which, the battery pack BAT is used as an energy storage unit to provide emergency power supply support for the auxiliary lighting lamp LED5; the charging management circuit 201 is configured to monitor and protect the charging process of the battery pack BAT to prevent the occurrence of overcharge or over-discharge phenomenon, so as to ensure the safety and the service life of the battery pack BAT; the battery charging circuit 203 charges the battery pack BAT by means of an external power supply and has a core function of efficiently storing electric energy into the battery pack BAT; the signal detection circuit 202 is configured to sense the sensing signal of the sensing module U5 and control the connection and disconnection between the auxiliary lighting control circuit 21 and the battery pack BAT according to a signal state; the battery pack BAT is respectively connected to the charging management circuit 201, the signal detection circuit 202 and the battery charging circuit 203 to form a complete charging and power supply loop; the charging management circuit 201 adjusts the output current of the battery charging circuit 203 by monitoring the voltage state of the battery pack BAT so as to avoid the overcharge of the battery pack BAT; the signal detection circuit 202 receives a signal (such as change on ambient light or moving object detected) from the sensing module U5; and when the auxiliary lighting lamp LED5 is detected to be required to be turned on, the signal detection circuit 202 will conduct the connection between the auxiliary lighting control circuit 21 and the battery pack BAT to supply power to the auxiliary lighting lamp LED 5. The whole circuit is compact in design and works cooperatively, which ensures normal operation of the auxiliary lighting lamp LED5 under the condition of mains supply interruption or other specific conditions, thereby improving the reliability of the system.

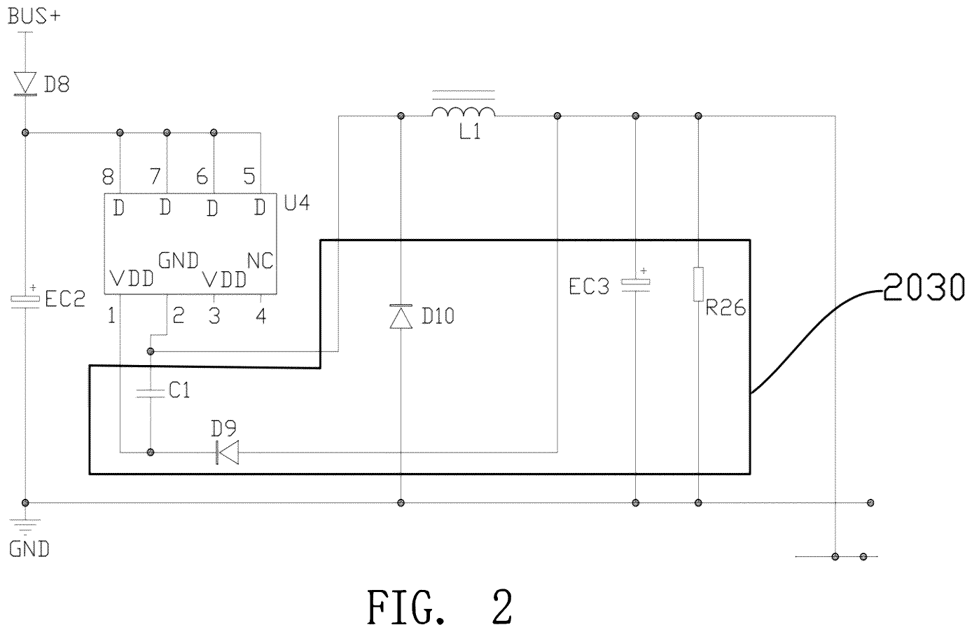

With reference to FIG. 1 to FIG. 2, in one embodiment, the battery charging circuit 203 includes a battery charging chip U4 and a filtering battery protection circuit 2030;
a first end of the battery charging chip U4 is connected to the charging management circuit 201 by means of a first inductor L1, and a second end of the battery charging chip U4 is connected to the signal detection circuit 202 by means of a first polar capacitor EC2 and is grounded; and
a first end of the filtering battery protection circuit 2030 is connected to the first end of the battery charging chip U4, and a second end of the filtering battery protection circuit 2030 is connected to the second end of the battery charging chip U4.

In the above embodiment, the battery charging circuit 203 mainly includes the battery charging chip U4 and the filtering battery protection circuit 2030, the first end of the battery charging chip U4 is connected to the charging management circuit 201 by means of the first inductor L1, and the second end of the battery charging chip U4 is connected to the signal detection circuit 202 by means of the first polar capacitor EC2 and is grounded, in which, the first end of the battery charging chip U4 includes a first supporting pin, a second supporting pin, a third supporting pin and a fourth supporting pin, and the second end of the battery charging chip U4 includes a fifth supporting pin, a sixth supporting pin, a seventh supporting pin and an eighth supporting pin; the second supporting pin of the battery charging chip U4 is connected to a first end of the first inductor L1, a second end of the first inductor L1 is connected to the charging management circuit 201; the fifth supporting pin, the sixth supporting pin, the seventh supporting pin and the eighth supporting pin of the battery charging chip U4 are simultaneously connected to a first end of the first polar capacitor EC2 in parallel and are connected to a positive electrode end of a bus by means of a diode D8, and the second end of the first polar capacitor EC2 is connected to the signal detection circuit 202 and is grounded;
a first end of the filtering battery protection circuit 2030 is connected to the first end of the battery charging chip U4, a second end of the filtering battery protection circuit 2030 is connected to the second end of the battery charging chip U4, and the filtering battery protection circuit 2030 includes a diode D9, a diode D10, a polar capacitor EC3, a resistor R26 and a capacitor C1; the polar capacitor EC3 and the resistor R26 are connected in parallel, a first end of the polar capacitor EC3 and a first end of the resistor R26 are connected to a connecting line between the second end of the first inductor L1 and the charging management circuit 201, and a second end of the polar capacitor EC3 and a second end of the resistor R26 are connected to a connecting line between the second end of the first polar capacitor EC2 and the signal detection circuit 202; a first end of the diode D10 is connected to a connecting line between the first end of the first inductor L1 and the second supporting pin of the battery charging chip U4, and a second end of the diode D10 is connected to a connecting line between the second end of the first polar capacitor EC2 and the signal detection circuit 202; a first end of the diode D9 is connected to the first supporting pin of the battery charging chip U4, and a second end of the diode D9 is connected to a connecting line between the second end of the first inductor L1 and the charging management circuit 201; a first end of the capacitor C1 is connected to a connecting line between the first end of the diode D9 and the first supporting pin of the battery charging chip U4, and a second end of the capacitor C1 is connected to a connecting line between the second supporting pin of the battery charging chip U4 and the first end of the first inductor L1; and therefore, by combining the battery charging chip U4 and the filtering battery protection circuit 2030, high-frequency noise in input current can be effectively filtered, the stability of the charging process is improved, damage to the battery pack BAT is reduced, the phenomena of reverse currents and overvoltage are effectively prevented, and as a result, the system safety is improved.

With reference to FIG. 1 to FIG. 3, in one embodiment, the signal detection circuit 202 includes a detection chip U6, a voltage stabilization filter circuit 2020 and a decoupling filter circuit 2021;
a first end of the detection chip U6 is connected to the charging management circuit 201, and a second end of the detection chip U6 is connected to the second end of the battery charging chip U4;
a first end of the voltage stabilization filter circuit 2020 is connected to the positive electrode end of the bus, and a second end of the voltage stabilization filter circuit 2020 is connected to a connecting line between the second end of the detection chip U6 and the second end of the battery charging chip U4; and
a first end of the decoupling filter circuit 2021 is connected to a connecting line between the first end of the detection chip U6 and the charging management circuit 201, and a second end of the decoupling filter circuit 2021 is grounded.

In the above embodiment, the signal detection circuit 202 includes the detection chip U6, the voltage stabilization filter circuit 2020 and the decoupling filter circuit 2021, in which, the detection chip U6 is used as the core element and configured to receive the signal from the sensing module U5 and control connection and disconnection between the battery pack BAT and the auxiliary lighting lamp LED5 according to the signal state. The first end (including first, second, fourth and fifth supporting pins) of the detection core U6 is connected to the charging management circuit 201, and the second end (including third, sixth, seventh and eighth supporting pins) of the detection chip U6 is connected to the second end of the battery charging chip U4, so that a complete signal transmission path is formed; the first supporting pin of the detection chip U6 is connected to the charging management circuit 201 and is configured to receive power input; the second supporting pin is connected to the second supporting pin of the sensing module U5 and is configured to receive the sensing signal from the sensing module U5; the seventh supporting pin is connected to the positive electrode end of the bus by means of the voltage stabilization filter circuit 2020 and is configured to stabilize the voltage; and the eighth supporting pin is connected to the second end of the battery charging chip U4 and is configured to transmit the processed signal to the battery charging chip U4. Moreover, the first supporting pin of the sensing module U5 is connected to the main lighting management unit 1, and the third supporting pin is connected between the first supporting pin of the detection chip U6 and the charging management circuit 201, so as to ensure accurate transmission of the signal;
the voltage stabilizing filter circuit 2020 includes a resistor R27, a capacitor C2, a voltage stabilizing diode ZD1A, a resistor R27A and a resistor R27B, in which, the resistor R27, the capacitor C2 and the voltage stabilizing diode ZD1A are connected in parallel; first ends of the resistor R27, the capacitor C2 and the voltage stabilizing diode ZD1A are connected to the positive electrode end of the bus, and second ends of the resistor R27, the capacitor C2 and the voltage stabilizing diode ZD1A are connected to a connecting line between the eighth supporting pin of the detection chip U6 and the second end of the battery charging chip U4; the resistor R27A and the resistor R27B are connected in series, first ends of the resistor R27A and the resistor R27B are connected to the positive electrode end of the bus, and second ends of the resistor R27A and the resistor R27B are connected to the first ends of the resistor R27, the capacitor C2 and the voltage stabilizing diode ZD1A, and meanwhile, the seventh supporting pin of the detection chip U6 is connected to the first ends of the resistor R27, the capacitor C2 and the voltage stabilizing diode ZD1A; the decoupling filter circuit 2021 includes a capacitor CA and a capacitor CB which are connected in parallel, first ends of the capacitor CA and the capacitor CB are connected to a connecting line between the first end of the detection chip U6 and the charging management circuit 201, and second ends of the capacitor CA and the capacitor CB are grounded; and by the combination of the detection chip U6 and the voltage stabilizing filter circuit 2020, noise in input signals can be effectively filtered, thus the accuracy of signal detection is improved, and mis-operation is avoided.

With reference to FIG. 1 to FIG. 4, in one embodiment, the charging management circuit 201 includes a charging management chip U7, a rectification protection circuit 2010 and an indicating circuit 2011;
the rectification protection circuit 2010 is connected to the first end of the battery charging chip U4, the first end of the detection chip U6 and the charging management chip U7 respectively;
a first end of the charging management chip U7 is connected to a positive electrode end of the battery pack BAT, and a second end of the charging management chip U7 is connected to a negative electrode end of the battery pack BAT and is grounded; and
a first end of the indicating circuit 2011 is connected to the first end of the charging management chip U7, and a second end of the indicating circuit 2011 is connected to the second end of the charging management chip U7.

In the above embodiment, the charging management circuit 201 includes the charging management chip U7, the rectification protection circuit 2010 and the indicating circuit 2011, in which, the charging management chip U7 is used as a core element and configured to control the charging state of the battery pack BAT; the first end (including fifth, sixth, seventh and eighth supporting pins) of the charging management chip U7 is connected to the positive electrode end of the battery pack BAT, and the second end (including first, second, third and fourth supporting pins) of the charging management chip U7 is connected to the negative electrode end of the battery pack BAT and is grounded; the fourth supporting pin of the charging management chip U7 is connected to the negative electrode end of the battery pack BAT by means of two parallel capacitors C3 and C4 and is grounded, and is configured to filter; the first supporting pin is connected between the negative electrode end of the battery pack BAT and a grounding line by means of the resistor R30 and is configured to detect current; the second supporting pin is connected between the negative electrode end of the battery pack BAT and the grounding line by means of the resistor R29 and is configured to further stabilize the circuit; the third supporting pin is directly grounded;
the rectification protection circuit 2010 consists of a diode DM and a diode DA and plays a role in preventing reverse current and protecting the circuit; a first end of the diode DM is connected to the fourth supporting pin of the charging management chip U7, and a second end of the diode DM is connected to the first supporting pin of the detection chip U6; the first end of the battery charging chip U4 is connected between the first end of the diode DM and the fourth supporting pin of the charging management chip U7; a first end of the diode DA is connected to the fifth supporting pin of the charging management chip U7, and a second end of the diode DA is connected between the second end of the diode DM and the first supporting pin of the detection chip U6, so that the stability of signal transmission is guaranteed; the indicating circuit 2011 consists of a light-emitting diode LED3 and a light-emitting diode LED4 and is configured to display the charging state; a first end of the LED3 is connected to the sixth supporting pin of the charging management chip U7, a first end of the LED4 is connected to the seventh supporting pin, and a second end of the LED3 and a second end of the LED4 are interconnected and are both connected to the fifth supporting pin of the charging management chip U7; in addition, the charging management circuit 201 further includes a capacitor C6, a first end of the capacitor C6 is connected between the fifth supporting pin of the charging management chip U7 and the positive electrode end of the battery pack BAT, and a second end of the capacitor C6 is connected between the fourth supporting pin of the charging management chip U7 and the negative electrode end of the battery pack BAT and is configured to further smooth voltage fluctuation; the third supporting pin (a pin 3 of U7) of the charging management chip U7 is a current control pin; the breakover current is detected and adjusted by means of the resistor RS, and therefore the current of the small night light is controlled, and the brightness adjusting function is achieved; and by the accurate control of the charging management chip U7, the battery pack BAT can be effectively prevented from being overcharged or overdischarged, thereby prolonging the service life of a battery, and improving the system safety.

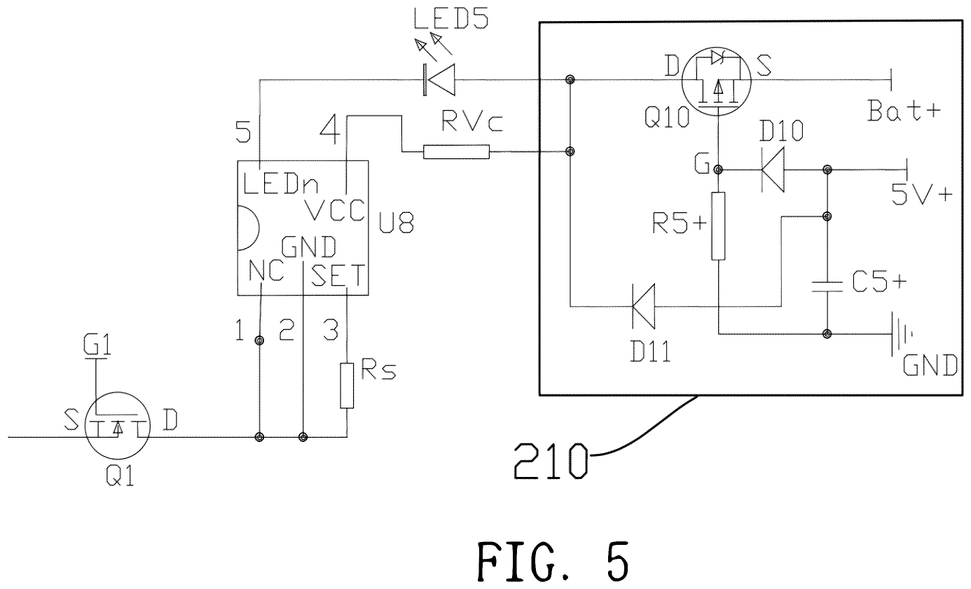

With reference to FIG. 1 and FIG. 5, in one embodiment, the auxiliary lighting control circuit 21 includes an auxiliary lighting control chip U8, a first transistor Q1 and a power switching protection circuit 210;
a source electrode of the first transistor Q1 is connected to the battery control circuit 20, and a drain electrode of the first transistor Q1 is connected to a first end of the auxiliary lighting control chip U8 by means of a first resistor RS; and a second end of the auxiliary lighting control chip U8 is connected to the power switching protection circuit 210 by means of a second resistor RVC, the first end of the auxiliary lighting lamp LED5 is connected to a second end of the auxiliary lighting control chip U8, and the second end of the auxiliary lighting lamp LED5 is connected to the power switching protection circuit 210.

In the above embodiment, the auxiliary lighting control circuit 21 includes the auxiliary lighting control chip U8, the first transistor Q1 and the power switching protection circuit 210, in which, the auxiliary lighting control chip U8 is used as a core element and is configured to receive the signal and control current output; the first end (including first, second and third supporting pins) of the auxiliary lighting control chip U8 is connected to the drain electrode of the first transistor Q1 by means of the first resistor RS, and the second end (including fourth and fifth supporting pins) of the auxiliary lighting control chip U8 is connected to the power switching protection circuit 210 by means of the second resistor RVC and is configured to directly drive the auxiliary lighting lamp LED5; the first transistor Q1 is an N-channel MOS tube, a source electrode of the first transistor Q1 is connected to the battery control circuit 20, and a drain electrode of the first transistor Q1 is connected to the first end (the third supporting pin) of the auxiliary lighting control chip U8 by means of the first resistor RS; the first supporting pin and the second supporting pin of the auxiliary lighting control chip U8 are simultaneously connected to a connecting line between the second end of the first resistor RS and the drain electrode of the first transistor Q1 and are configured to receive an input signal and control current flowing direction; the fourth supporting pin of the auxiliary lighting control chip U8 is connected to the power switching protection circuit 210 by the second resistor RVC, and the fifth supporting pin of the auxiliary lighting control chip U8 is directly connected to the first end (one end of the LED 5) of the auxiliary lighting lamp LED5; the second end of the auxiliary lighting lamp LED5 is connected to the power switching protection circuit 210 and forms a parallel relationship with the second resistor RVC; moreover, when the pin 7 of the U6 detects a low level by means of the R27A, R27B, R27, ZD1 and C2, the sensing module U5 will output a high level to the pin 2 of the U6, then the pin 6 of the U6 outputs a high level to switch on the first transistor Q1G1, a positive electrode of a lithium battery passes through the first transistor Q1Q10 at the moment to supply power to the auxiliary lighting control chip U8U7, so as to form a complete loop to turn on the auxiliary lighting lamp LED5; and by the matching of the auxiliary lighting control chip U8 and the first transistor Q1, the amplitude of current flowing through the auxiliary lighting lamp LED5 can be accurately adjusted, so that flexible adjustment of brightness of the auxiliary lighting lamp LED5 is achieved, and the demand under different scenes is met

With reference to FIG. 1 and FIG. 5, in one embodiment, the power switching protection circuit 210 includes a second transistor Q10, a third resistor R5+ and a diode set;
a drain electrode of the second transistor Q10 is connected to the second end of the auxiliary lighting lamp LED5, a grid electrode of the second transistor Q10 is connected to a first end of the third resistor R5+, and a second end of the third resistor R5+ is grounded; and
a first end of the diode set is connected to a connecting line between the grid electrode of the second transistor Q10 and the first end of the third resistor R5+, and a second end of the diode set is connected to a connecting line between the second end of the second resistor RVC and the second end of the auxiliary lighting lamp LED 5.

In the above embodiment, the power switching protection circuit 210 includes the second transistor Q10, the third resistor R5+ and the diode set, in which, the second transistor Q10 is an N-channel MOS transistor, a drain electrode of the second transistor Q10 is connected to the second end of the auxiliary lighting lamp LED5, a grid electrode of the second transistor Q10 is grounded by means of the third resistor R5+, a source electrode of the second transistor Q10 is connected to a positive electrode of a battery, and a diode is arranged in the second transistor Q10 to prevent overvoltage damage; the third resistor R5+ plays a role in current limiting, a first end of the third resistor R5+ is connected to the grid electrode of the second transistor Q10, and a second end of the third resistor R5+ is grounded; the diode set includes a diode D10, a diode D11 and a capacitor C5+ and is configured to further protect the circuit and provide stable voltage support; a first end of the diode D10 is connected between the grid electrode of the second transistor Q10 and the first end of the third resistor R5+, and a second end of the diode D10 is connected to the first end of the capacitor C5+ and is connected to 5V+ voltage; the second end of the capacitor C5+ is connected to a second end of the third resistor R5+ and the grounding line and is configured to filter and smooth voltage fluctuation; a first end of the diode D11 is connected between the first end of the diode D10 and the first end of the capacitor C5+, and a second end of the diode D11 is connected between the second end of the second resistor RVC and the second end of the auxiliary lighting lamp LED5, so as to form a complete current loop.

When a wall switch is turned off, the U5 will serve as a module with built-in light sensing and built-in microwave sensing functions; in the daytime, the pin 2 of the U5 outputs the low level by the light sensing function, thus the U6 always outputs the low level, the G1 (the first transistor Q1) cannot be switched on, and the small night light is kept in an off state. At night, the resistance value of the light sensor decreases, after the U5 detects the moving object, the pin 2 will output the high level, then the pin 6 of the U6 outputs the high level to switch on the G1, and current of the lithium battery flows to the auxiliary lighting lamp LED5 through the second transistor Q10 to turn on the small night light; if no moving object is detected within 90 s, the pin 2 of the U5 will output the low level again, then the pin 6 of the U6 also outputs the low level, thus the G1 is switched off, and the small night light will be turned off; by the matching of the second transistor Q10 and the third resistor R5+, the current flowing direction can be accurately controlled, thus safe operation of the auxiliary lighting lamp LED5 is ensured, and moreover, damage caused by too large current or voltage fluctuation is avoided, and the reliability and user experience of the whole system are improved.

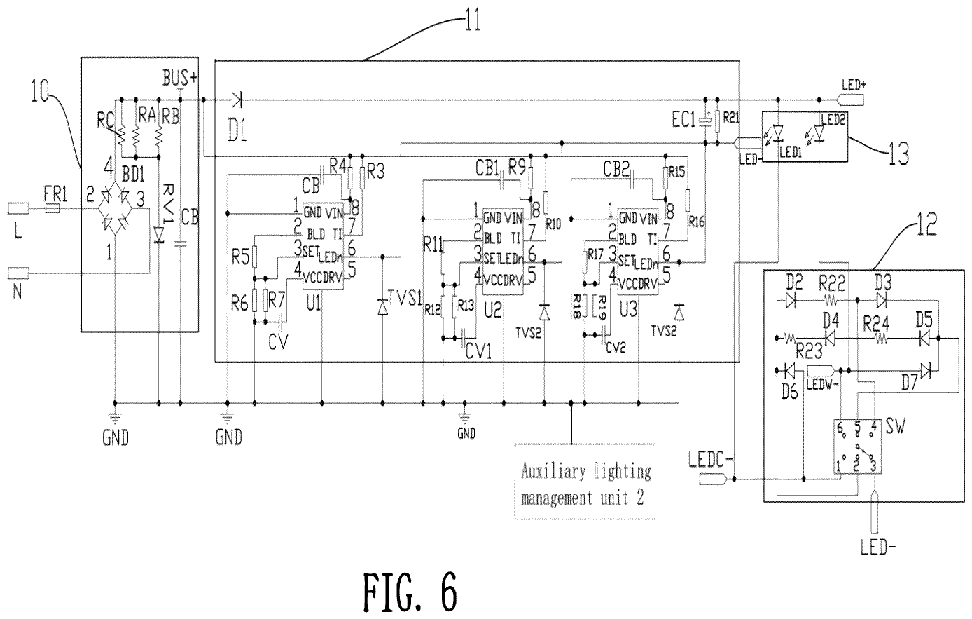

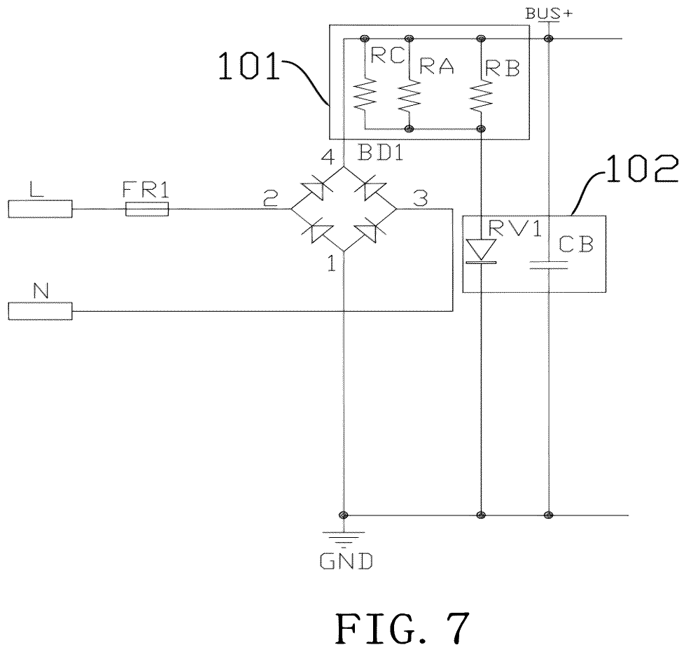

With reference to FIG. 1, and FIG. 6 to FIG. 7, in one embodiment, the main lighting management unit 1 includes a rectification filter circuit 10, a main lighting control circuit 11 and the main lighting lamp 13, in which, the rectification filter circuit 10 is connected to the main lighting lamp 13 by means of the main lighting control circuit 11, and the rectification filter circuit 10 includes a rectifier diode BD1, a resistor set 101 and a surge circuit 102;
a first end of the rectifier diode BD1 is connected to the mains supply, a second end of the rectifier diode BD1 is connected to the resistor set 101 and the surge circuit 102 respectively, and the resistor set 101 is connected to the surge circuit 102.

In the above embodiment, the main lighting management unit 1 is configured to convert the mains supply into direct current suitable for the main lighting lamp 13 to work and drive the main lighting lamp 13 by means of the main lighting control circuit 11; the main lighting management unit 1 mainly includes the rectification filtering circuit 10, the main lighting control circuit 11 and the main lighting lamp 13, in which, the rectification filtering circuit 10 is formed by the rectifier diode BD1, the resistor set 101 and the surge circuit 102; the rectifier diode BD1 is configured to convert AC mains supply into unidirectional pulsating DC, a first end (including second and third supporting pins) of the rectifier diode BD1 is respectively connected to an L end (by a fuse FR1) and an N end of the mains supply, a second end (including first and fourth supporting pins) of the rectifier diode BD1 is connected to a subsequent circuit; the second supporting pin of the rectifier diode BD1 is connected to the L end of the mains supply by means of the fuse FR1, and the third supporting pin of the rectifier diode BD1 is connected to the N end of the mains supply; the resistor set 101 is formed by three resistors RC, RA and RB which are connected in parallel and plays roles of current limiting and voltage dividing; a first end of the resistor set 101 is connected to the fourth supporting pin of the rectifier diode BD1, and a second end of the resistor set 101 is connected to the first end of a diode RV1 in the surge circuit 102; the surge circuit 102 consists of the diode RV1 and the capacitor CB and is configured to filter rectified voltage fluctuation and limit the voltage in a safety range; a first end of the diode RV1 is connected to the second end of the resistor set 101, and a second end of the diode RV1 is connected to a connecting line between the first supporting pin of the rectifier diode BD1 and the main lighting control circuit 11 and is grounded; a first end of the capacitor CB is connected to a connecting line between the first end of the resistor set 101 and the main lighting control circuit 11, and a second end of the capacitor CB is connected to a connecting line between the first supporting pin of the rectifier diode BD1 and the main lighting control circuit 11 and is grounded; and due to the design of the rectification filtering circuit 10, the mains supply can be effectively converted into stable DC, thus the normal work of the main lighting lamp 13 is ensured, efficient and stable lighting support can be provided for the users in various environments, and the performance of the whole system and the user experience are improved.

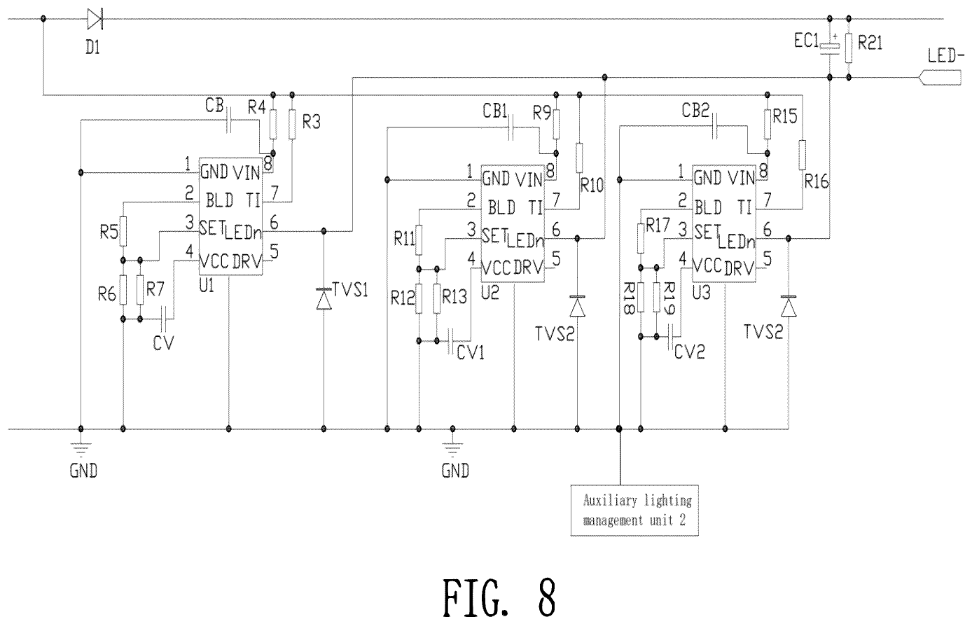

With reference to FIG. 1, and FIG. 6 to FIG. 8, in one embodiment, the main lighting control circuit 11 includes a main lighting control chip, a linear voltage reduction dimming circuit and a filtering phase shift circuit;
a first end of the main lighting control chip is connected to a first end of the filtering phase shift circuit, and a second end of the filtering phase shift circuit is connected to the first supporting pin of the second end of the rectifier diode BD1; and
a second end of the main lighting control chip is connected to a first end of the linear voltage reduction dimming circuit, and a second end of the linear voltage reduction dimming circuit is connected to the fourth supporting pin of the second end of the rectifier diode BD1 and the main lighting lamp 13 respectively.

In the above embodiment, the main lighting control circuit 11 includes the main lighting control chip, the linear voltage reduction dimming circuit and the filtering phase shift circuit, in which, the main lighting control circuit 11 is formed by connecting three same circuits in parallel, and there may be three main lighting control chips (U1, U2 and U3); in this embodiment, the main lighting control chip U1 is taken as an example for description, the first end of the main lighting control chip includes a first supporting pin, a second supporting pin, a third supporting pin and a fourth supporting pin, the second end of the main lighting control chip includes a fifth supporting pin, a sixth supporting pin, a seventh supporting pin and an eighth supporting pin, and the filtering phase shift circuit includes a resistor R5, a resistor R6, a resistor R7 and a capacitor CV; the first supporting pin of the main lighting control chip is connected to a connecting line between the first supporting pin of the rectifier diode BD1 and the ground, and the second supporting pin of the main lighting control chip is connected to a first end of the resistor R5; a second end of the resistor R5 is connected to a first end of the resistor R6, a second end of the resistor R6 is connected to a connecting line between the first supporting pin of the rectifier diode BD1 and the ground, and the resistor R5 and the resistor R6 are connected in series; the third supporting pin of the main lighting control chip is connected to a first end of the resistor R7, and the fourth supporting pin of the main lighting control chip is connected to a first end of the capacitor CV; a second end of the capacitor CV is connected to lines of the second end of the resistor R6 and the ground, the second end of the resistor R7 is connected to lines of the second end of the resistor R6 and the second end of the capacitor CV, and the resistor R6 and the resistor R7 are connected in parallel;
the linear voltage reduction dimming circuit includes a resistor R3, a resistor R4, a capacitor CB, a diode D1, a resistor R21 and a polar capacitor EC1; the sixth supporting pin of the main lighting control chip is connected to a negative electrode end of the main lighting lamp 13 and is also connected to the first supporting pin of the rectifier diode BD1 by means of a diode TVS1; the seventh supporting pin of the main lighting control chip is connected to a positive electrode end of the main lighting lamp 13 sequentially by means of the resistor R3 and the diode D1; the eighth supporting pin of the main lighting control chip is connected to a first end of the resistor R4, and a second end of the resistor R4 is connected to a line between the resistor R3 and the diode D1; a first end of the capacitor CB is connected to a connecting line between the eighth supporting pin of the main lighting control chip and the first end of the resistor R4, and a second end of the capacitor CB is connected to the first supporting pin of the main lighting control chip; the resistor R21 and the polar capacitor EC1 are connected in parallel, first ends of the resistor R21 and the polar capacitor EC1 are connected to a connecting line between the diode D1 and the positive electrode end of the main lighting lamp 13, and second ends of the resistor R21 and the polar capacitor EC1 are connected to a connecting line between the sixth supporting pin of the main lighting control chip and the negative electrode end of the main lighting lamp 13; therefore, due to the design of the filtering phase-shifting circuit, the phase of the input signal can be effectively adjusted and high-frequency noise can be filtered, so that the stability of the circuit is improved; stable current output is provided for the main lighting lamp 13 by means of the linear voltage reduction dimming circuit, so that the damage caused by voltage fluctuation is avoided; and in addition, the reliability of the system is strengthened by the multi-path parallel design of the main lighting control chip, and continuous stable operation under a high-load condition is realized.

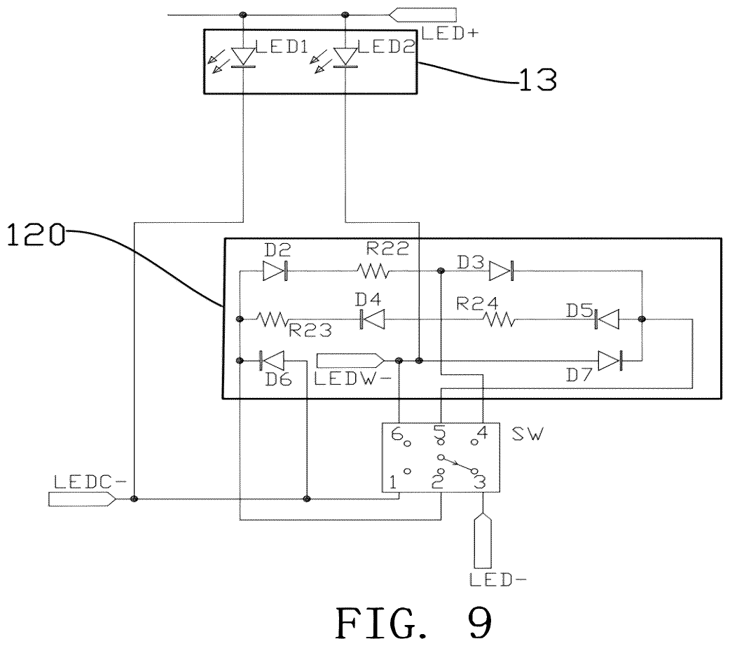

With reference to FIG. 1, and FIG. 6 to FIG. 9, in one embodiment, the main lighting management unit 1 further includes a color temperature control circuit 12; and
the color temperature control circuit 12 includes a multi-position switch SW and a current distribution circuit 120, and the multi-position switch SW is connected to the main lighting lamp 13 by means of the current distribution circuit 120.

In the above embodiment, the main lighting management unit 1 further includes the color temperature control circuit 12, and the color temperature control circuit 12 includes the multi-position switch SW and the current distribution circuit 120, in which, the multi-position switch SW is connected to the main lighting lamps 13 by means of the current distribution circuit 120; the multi-position switch SW is a six-position switch including a first supporting pin, a second supporting pin, a third supporting pin, a fourth supporting pin, a fifth supporting pin and a sixth supporting pin; two main lighting lamps 13 are provided, and each includes a light-emitting diode LED1 and a light-emitting diode LED 2; the current distribution circuit 120 includes a diode D2, a diode D3, a diode D4, a diode D5, a diode D6, a diode D7, a resistor R22, a resistor R23 and a resistor R24; the diode D2, the resistor R22 and the diode D3 are sequentially connected in series to form a first group of color temperature mixing circuits of the current distribution circuit 120; the resistor R23, the diode D4, the resistor R24 and the diode D5 are sequentially connected in series to form a second group of color temperature mixing circuits of the current distribution circuit 120; moreover, the first group of color temperature mixing circuits and the second group of color temperature mixing circuits are connected in parallel; the first supporting pin of the multi-position switch SW is connected to a first end of the light-emitting diode LED1 and connected to an LED-end in the color temperature control circuit 12, and a second end of the light-emitting diode LED1 is connected to the main lighting control circuit 11;
the second supporting pin of the multi-position switch SW is connected to a first end of the first group of color temperature mixing circuits and a first end of the second group of color temperature mixing circuits; the fifth supporting pin of the multi-position switch SW is connected to a second end of the first group of color temperature mixing circuits and the second end of the second group of color temperature mixing circuits; the fourth supporting pin of the multi-position switch SW is connected to a line between the resistor R22 and the diode D3; the sixth supporting pin of the multi-position switch SW is connected to a first end of the diode D7 and connected to an LEDW-end in the color temperature control circuit 12, and a second end of the diode D7 is connected to a connecting line between the diode D5 and the fifth supporting pin of the multi-position switch SW; a first end of the light-emitting diode LED2 is connected to a connecting line between the sixth supporting pin of the multi-position switch SW and a first end of the diode D7, and a second end of the light-emitting diode LED2 is connected to the main lighting control circuit 11; a first end of the diode D6 is connected to a connecting line between the first supporting pin of the multi-position switch SW and the first end of the light-emitting diode LED1, and a second end of the diode D6 is connected to a connecting line between the second supporting pin of the multi-position switch SW and a second end of the resistor R23 in the second color temperature mixing circuit; the third supporting pin of the multi-position switch SW is connected to the LED-end; and therefore, by the selection function of the multi-position switch SW, the user can conveniently switch different color temperature modes, and thus diversified requirements are met; and in addition, due to the design of the current distribution circuit 120, the proportion of currents flowing through the LED1 and the LED2 is accurately adjusted, dynamic mixing of cold white light and warm white light is achieved, and a smooth color temperature transition effect is provided.

The above is only a preferred embodiment of the present invention, and does not limit the patent scope of the present invention, and all equivalent structure or equivalent process transformations made by using the contents of the description and drawings of the present invention, or directly or indirectly used in other related technical fields, are similarly included in the patent protection scope of the present invention.

What is claimed is:

1. A lighting control circuit, comprising a main lighting management unit, and an auxiliary lighting management unit connected to the main lighting management unit, wherein
the auxiliary lighting management unit comprises an auxiliary lighting lamp, a battery control circuit, an auxiliary lighting control circuit, and a sensing module, wherein the auxiliary lighting lamp is connected to the auxiliary lighting control circuit, and the auxiliary lighting control circuit is configured to adjust the brightness of the auxiliary lighting lamp;
the battery control circuit is connected to the auxiliary lighting lamp by means of the auxiliary lighting control circuit, and is configured to normally supply power to the auxiliary lighting lamp after power failure; and
a first end of the sensing module is connected to the main lighting management unit, a second end of the sensing module is connected to the auxiliary lighting control circuit by means of the battery control circuit, and the sensing module is configured to control an on-off state of the auxiliary lighting lamp according to external ambient light and whether a moving object exists.

2. The lighting control circuit according to claim 1, wherein the battery control circuit comprises a battery pack, a charging management circuit, a signal detection circuit and a battery charging circuit which are connected to the battery pack respectively; the signal detection circuit is configured to detect a sensing signal of the sensing module and control the state of connection and disconnection between of the auxiliary lighting control circuit and the battery pack; the battery charging circuit is configured to charge the battery pack; and the charging management circuit is configured to control the charging state of the battery pack.

3. The lighting control circuit according to claim 2, wherein the battery charging circuit comprises a battery charging chip and a filtering battery protection circuit;
a first end of the battery charging chip is connected to the charging management circuit by means of a first inductor, and a second end of the battery charging chip is connected to the signal detection circuit by means of a first polar capacitor and is grounded; and
a first end of the filtering battery protection circuit is connected to the first end of the battery charging chip, and the second end of the filtering battery protection circuit is connected to the second end of the battery charging chip.

4. The lighting control circuit according to claim 3, wherein the signal detection circuit comprises a detection chip, a voltage stabilization filter circuit and a decoupling filter circuit;
a first end of the detection chip is connected to the charging management circuit, and a second end of the detection chip is connected to the second end of the battery charging chip;
a first end of the voltage stabilization filter circuit is connected to a positive electrode end of a bus, and a second end of the voltage stabilization filter circuit is connected to a connecting line between the second end of the detection chip and the second end of the battery charging chip; and
a first end of the decoupling filter circuit is connected to a connecting line between the first end of the detection chip and the charging management circuit, and the second end of the decoupling filter circuit is grounded.

5. The lighting control circuit according to claim 4, wherein the charging management circuit comprises a charging management chip, a rectification protection circuit and an indicating circuit;
the rectification protection circuit is connected to the first end of the battery charging chip, the first end of the detection chip and the charging management chip respectively;
a first end of the charging management chip is connected to a positive electrode end of the battery pack, and a second end of the charging management chip is connected to a negative electrode end of the battery pack and is grounded; and
a first end of the indicating circuit is connected to the first end of the charging management chip, and a second end of the indicating circuit is connected to the second end of the charging management chip.

6. The lighting control circuit according to claim 1, wherein the auxiliary lighting control circuit comprises an auxiliary lighting control chip, a first transistor and a power switching protection circuit;
a source electrode of the first transistor is connected to the battery control circuit, and a drain electrode of the first transistor is connected to the first end of the auxiliary lighting control chip by means of a first resistor; and
a second end of the auxiliary lighting control chip is connected to the power switching protection circuit by means of a second resistor, a first end of the auxiliary lighting lamp is connected to the second end of the auxiliary lighting control chip, and a second end of the auxiliary lighting lamp is connected to the power switching protection circuit.

7. The lighting control circuit according to claim 6, wherein the power switching protection circuit comprises a second transistor, a third resistor and a diode set;
a drain electrode of the second transistor is connected to the second end of the auxiliary lighting lamp, a grid electrode of the second transistor is connected to a first end of the third resistor, and a second end of the third resistor is grounded; and
a first end of the diode set is connected to a connecting line between a grid electrode of the second transistor and a first end of the third resistor, and a second end of the diode set is connected to a connecting line between a second end of the second resistor and the second end of the auxiliary lighting lamp.

8. The lighting control circuit according to claim 1, wherein the main lighting management unit comprises a rectification filter circuit, a main lighting control circuit and a main lighting lamp; the rectification filter circuit is connected to the main lighting lamp by means of the main lighting control circuit, and the rectification filter circuit comprises a rectifier diode, a resistor set and a surge circuit;
a first end of the rectifier diode is connected to the mains supply; and a second end of the rectifier diode is connected to the resistor set and the surge circuit, and the resistor set is connected to the surge circuit.

9. The lighting control circuit according to claim 8, wherein the main lighting control circuit comprises a main lighting control chip, a linear voltage reduction dimming circuit and a filtering phase shift circuit;
a first end of the main lighting control chip is connected to a first end of the filtering phase shift circuit, and a second end of the filtering phase shift circuit is connected to a first supporting pin of a second end of the rectifier diode; and
a second end of the main lighting control chip is connected to a first end of the linear voltage reduction dimming circuit, and a second end of the linear voltage reduction dimming circuit is connected to a fourth supporting pin of the second end of the rectifier diode and the main lighting lamp respectively.

10. The lighting control circuit according to claim 8, wherein the main lighting management unit further comprises a color temperature control circuit; and
the color temperature control circuit comprises a multi-position switch and a current distribution circuit, and the multi-position switch is connected to the main lighting lamp by means of the current distribution circuit.
